(19) United States
(12) Patent Application Publication
(10) Pub. No.: US 2012/0223174 A1
(43) Pub. Date: Sep. 6, 2012

(54) CARTRIDGE HAVING A RECESSED POWER SPRING FOR MANAGING EAR BUD CABLES

(75) Inventor: Daniel C. Sullivan, Santa Barbara, CA (US)

(73) Assignee: HEADLOGIC LLC, Westlake Village, CA (US)

(21) Appl. No.: 13/366,055

(22) Filed: Feb. 3, 2012

Related U.S. Application Data
(60) Provisional application No. 61/447,816, filed on Mar. 1, 2011.

(51) Int. Cl. B65H 75/48; F03G 1/08; F03G 1/02

(52) U.S. Cl. 242/371; 185/37

(57) ABSTRACT

A cartridge for managing an ear bud cable includes a housing having an input jack that is electronically connectable to an audio-source and a hub electrically connected with the input jack. A spool rotatably mounts on, and is electrically connected with, the hub. A power gear mounts in the housing and in contact with the spool for rotating the spool. The power gear defines a recessed interior. An ear bud cable wraps at least partially around the spool. A power gear spring mounts within the recessed interior of the power gear to minimize the size and, particularly, the thickness of the cartridge. In an alternate embodiment, the spool includes a recessed portion and a spool power spring mounts within the recessed portion of the hub. In yet another embodiment, the spool and the power gear both have recessed portions that hold a power spring.

### PRIORITY CLAIM

This invention claims priority to U.S. Provisional Patent Application Ser. No. 61/447,816, which was filed 1 Mar. 2011, the disclosure of which is incorporated herein by reference.

### FIELD OF THE INVENTION

The present invention relates to ear bud cables and particularly to devices for dispensing and retracting ear bud cables.

### BACKGROUND OF THE INVENTION

Ongoing research indicates a relationship between prolonged exposure to cell phone radiation and illness. The risk of illness decreases significantly where cell phones are used at a distance from the user. Positioning a cell phone even a few inches away the ear can greatly reduce harm from cell phone radiation.

There are several ways to manage the health risks associated with prolonged cell phone use. One way is to use a speakerphone and hold the phone at a distance. However, many do not want their phone conversations overheard, or to disturb others with a loud two way conversation. Additionally, prolonged use of the speakerphone can greatly reduce battery life.

Another way to reduce health risks associated with cell phone use is to use a Bluetooth headset. The energy radiated by a phone with a typical Bluetooth headset is orders of magnitude less than a cellular phone signal, which typically is communicated between the cell phone and a distant cell phone tower. One drawback of a Bluetooth headset is that there is often a reduction in sound quality when compared to the sound quality of wired connections. Audiophiles also demand stereo sound, which is unavailable with single-ear bud Bluetooth headset models.

Yet another way to reduce health risks is to use a wired headset. Wired ear buds may, for example, insert into a user's ear, hang on the ear, or hang on the head. Ear buds are energy efficient and have lessened health risks due to radiation. When two ear buds are used, stereo sound is possible.

One major drawback of using wired ear buds with portable consumer electronics devices and telephones is cord management. Cord management is a commonly experienced problem where the cord of the ear buds becomes tangled and may be damaged by a frustrated user who attempts to hastily untangle the cord. Operating an automobile, a bicycle, or other vehicle while experiencing cord management problems can be dangerous. What is desired is a better way of cord management which enables the user to readily extend and retract ear bud cables in a rapid and reliable manner. What is also desired is a cartridge for cord management that is small in size and thickness.

### SUMMARY OF THE INVENTION

The present invention includes a cartridge for managing an ear bud cable includes a housing having an input jack that is electronically connectable to an audio-source. A hub is fixed in the housing, the hub being electrically connected with the input jack. A spool rotatably mounts on the hub, the spool being electrically connected with the hub. A power gear mounts in the housing and in contact with the spool for rotating the spool. The power gear defines a recessed interior. An ear bud cable wraps at least partially around the spool.

A power gear spring mounts within the recessed interior of the power gear to minimize the size and, particularly, the thickness of the cartridge.

In an alternate embodiment, the hub includes a recessed portion and a hub power spring mounts within the recessed portion of the hub. In this embodiment, the power gear and the spool are a single unit to minimize the size of the cartridge.

In yet another embodiment, the spool and the power gear both have recessed portions that hold a power spring. The spool power spring and the power gear power spring cooperate to rotate the spool.

The invention also encompasses a power gear for use in a cartridge for managing ear bud cables. The power gear includes an exterior having gear teeth, an interior that is recessed for holding a power spring, and a spring mounted in the interior for rotating the power gear.

The power gear is generally circular in shape to provide consistent torque. The spring, according to one aspect of the invention is a spiral torsion spring. The power gear has a textured interior, which mates with the spring to enable the spring to be adjustably mounted in the power gear. Preferably, the spring has a hooked end.

### BRIEF DESCRIPTION OF THE DRAWINGS

FIG. 1 shows a perspective view of a cord management cartridge in accordance with the present invention.

FIG. 2 shows a perspective view of the cord management cartridge retracting an ear bud cable.

FIG. 3 shows an exploded perspective view of a cord management cartridge.

FIG. 4 shows bottom perspective view of a power gear having a recessed interior with a power spring.

FIG. 5 shows a perspective view of a cartridge having a power gear and a spool with a power spring.

### DETAILED DESCRIPTION

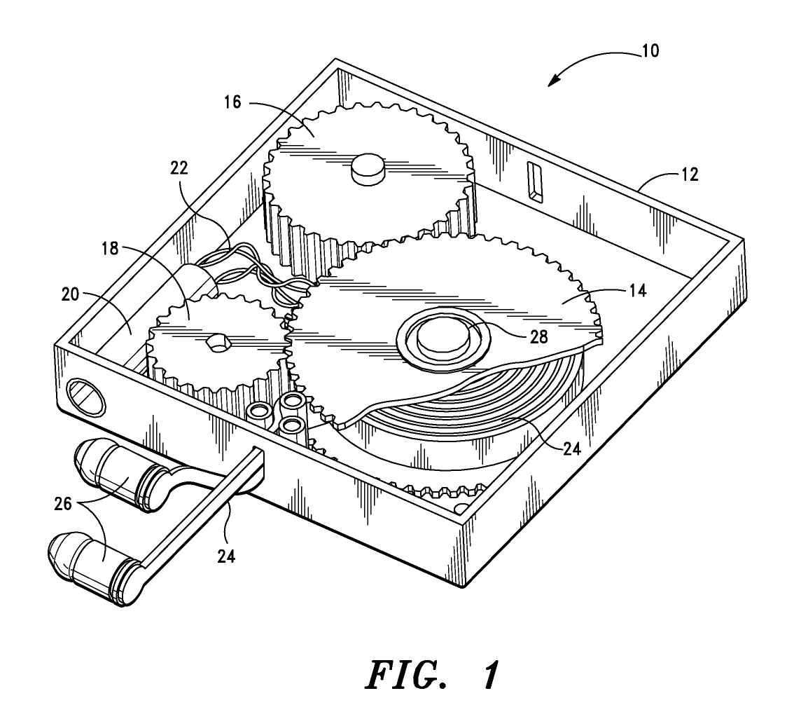

FIG. 1 is a cartridge generally designated by the reference numeral 10. The cartridge 10 includes housing 12, a spool 14, a power gear 16, a rotary damper gear 18, an input jack 20, an electrical connector 22, an ear bud cable 24, ear buds 26 and a hub 28.

The hub 28 is fixed within the housing 12. The spool 14 rotatably mounts on the hub 28. Rotation of the spool 14 dispenses and retracts the ear bud cable 24 from the housing 12.

The rotary damper gear 18 is rotatably mounted within the housing 12. The rotary damper gear 18 mates in operative engagement with the spool 14 so that the rotary damper gear 18 presses against the spool 14. In particular, both the rotary damper gear 18 and the spool 14 each have a periphery. The periphery of the rotary damper gear 18 and the periphery of the spool 14 press against each other in a direction tangential to the respective peripheries, and may press against each other in a radial fashion. The rotary damper gear 18 and the spool 14 mate so that free rotation of the spool 14 is inhibited by the rotary damper gear 18.

In this way, the rotary damper gear 18 limits the maximum angular velocity of the spool 14. Limiting the angular velocity of the spool 14 protects the cartridge 10 from damage. Limiting the angular velocity of the spool 14, in cooperation with the rotary damper gear 18 pressing against the spool 14 inhibits misalignment of the spool 14 to maximize durability of the cartridge 10. Preferably the rotary damper gear 18 and the spool 14 include peripheral gear teeth which mate to further improve alignment to optimize movement of the moving components, and improve cartridge 10 reliability.

When gear teeth are used, improved tangential pressure is achieved between the spool 14, the rotary damper gear 18 and the power gear 16. An element of radial force is also applied between these elements when one of the elements misaligns. Thus the function of the gears includes maintaining alignment of the spool 14. Improved alignment of the spool increases the reliability of the cartridge 10.

Although the use of the power gear 16 in a rotary damper gear are disclosed here in it can be appreciated that many ways of providing power to the spool 14 can be devised. Furthermore many ways of regulating the angular velocity of the spool 14 can also be provided. For example at dampening mechanism may include a leaf spring mounted within the housing which presses on the peripheral surface of the spool 14 can create sufficient frictional force to dampen rotation of the spool 14.

Additionally a power mechanism such as a spiral power spring can be mounted on the housing with respect to the spool 14 so that the spring directly contacts the spool 14 and thereby powers the spool.

Furthermore, linkages such as a chain, a belt, or other mechanical transmission mechanism can be used to regulate rotation of the spool.

The ear bud cable 24 wraps at least partially around the spool 14. The ear bud cable 24 as a first end attached within the spool and a second and attached to ear buds 26. The ear bud cable 24 is flat to optimize alignment of the cable 24 within the spool 14 when the cable is retracted and dispensed. Utilizing a flat cable 24 minimizes the thickness of the cable to maximize the length of the cable that can be wrapped around the spool 14. The flat cable 24 minimizes entanglement of the cable 24, as compared to the use of a round cable.

The cartridge 10 utilizes the power gear 16 to selectively rotate the spool 14, or to assist in spool 14 rotation. The power gear can be externally actuated by a switch operated by a user, or by pulling the cable 24 in the way traditional window shade works. In particular, a quick pull of the cable 24 causes the power gear and the spool 14 to retract the cable 24, and a slower pull of the cable 24 enables the power gear and the spool to dispense the cable 24. The power gear 16 can be calibrated to assist in response a desired pressure applied on the cable 24.

Rotation of the power gear 16 in one direction retracts the cable 24. Counter rotation of the power gear 16 dispenses the cable 24. The power gear 16 has a periphery which presses against the periphery of the spool. Preferably the power gear 16 has peripheral gear teeth which mate with the peripheral gear teeth of the spool 14 to improve alignment and reliability of the cassette 10. The power gear 16 is spring biased to apply consistent torque to the spool 14. Applying consistent torque to the spool 14 helps to maintain a relatively constant angular velocity of the spool 14. The cooperation of the power gear 16 and the rotary dampening gear 18 assure that a constant angular velocity of the spool 14 will be achieved to cartridge 10 reliability.

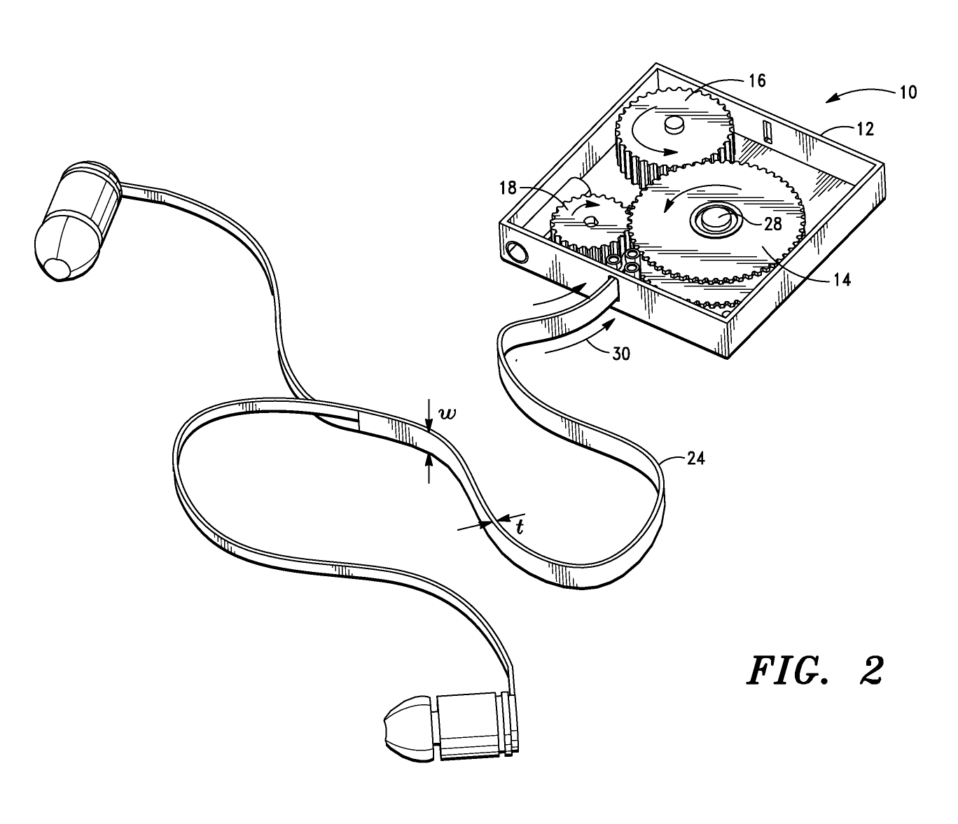

FIG. 2 shows rotation of the power gear 16 causing counter rotation of the spool 14, which retracts ear bud cable 24 in the direction of the arrow 30. The rotary damper gear 18 rotates in response to rotation of the spool 14 to regulate the angular velocity of the spool 14 as well as the rate of retraction of the ear bud cable 24. Regulation of the rate of retraction of the ear bud cable 24 increases reliability of the cartridge 10 by inhibiting misalignment of the cable 24 within the spool 14.

Although the rotary damper gear 18 and the power gear 16 are shown as separate elements, it can be appreciated that the function of these two elements can be combined into a single element to minimize size and weight of the cartridge 10.

The cable 24 has a width “w” and a thickness “t”. The cable 24 is flat and the thickness “t” is thinner than half of the width “w”. Preferably, the thickness “t” is minimized to enable cartridge 10 to maximize the amount of cable 24 that can be managed by the cartridge 10.

The cable 24 preferably includes a microphone for use with telephonic applications. The microphone enables the input jack to simultaneously function as an output jack.

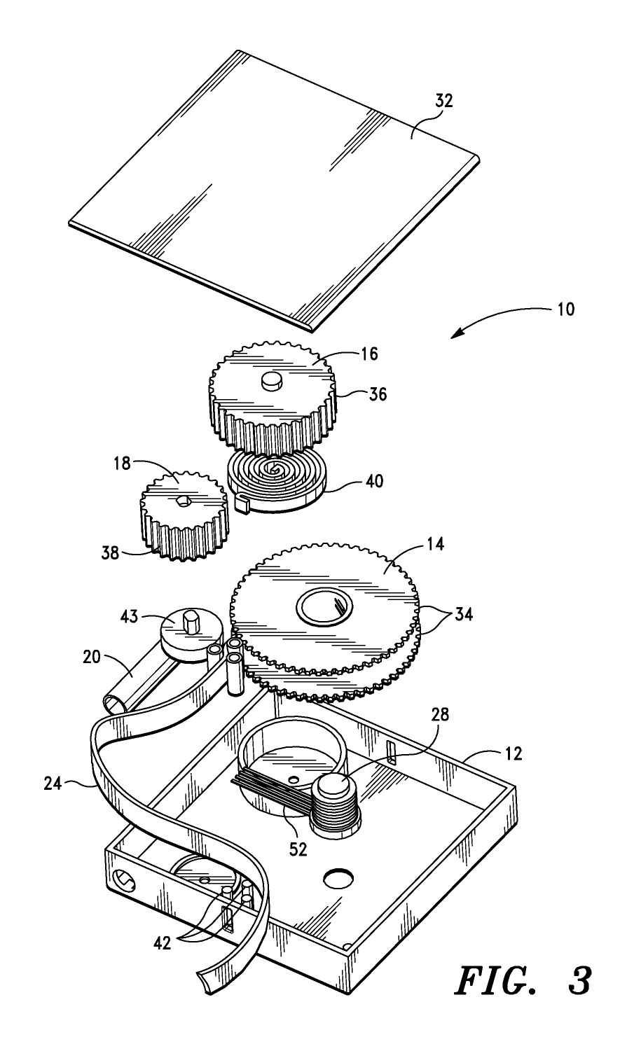

FIG. 3 shows the cartridge 10 including the housing 12 and a cover 32, which encloses the housing 12. The housing includes a hub 28 within the housing 12 the hub 28 is sized to receive the spool 14 in operative engagement. The hub 28 includes electrical connectors 52, which communicate electronically with the input jack 20.

The power gear 16 defines peripheral gear teeth 36 and includes a power gear spring 42 to actuate the power gear 16. The power gear spring 40 attaches to the housing 12 and to the power gear 16 to selectively apply torque to the power gear 16. Ideally, the torque would be uniform in magnitude.

When the power gear spring 40 applies torque to the power gear 16 the power gear 16 rotates the spool 14 to selectively retract or dispense the cable 24. When the spool 14 rotates the rotary damper gear 18 regulates the angular velocity of the spool 14 the rotary damper gear 18 includes gear teeth 38 defined on the periphery of the rotary damper gear teeth 38 meet with peripheral gear teeth 34 of the spool 14. In particular, the spool 14 has two sets of peripheral gear teeth 34 that parallel each other and simultaneously meet with the gear teeth 38 of the rotary damper gear.

The cartridge 10 also includes a rotary damper 43 attached between the housing 12 and the rotary damper gear 18. The rotary damper 43 is fixed within the housing 12 and includes a rotatable axle for receiving the rotary damper gear 18. The axle enables rotation of the rotary damper gear 18 on the axle. The rotary damper 43 regulates angular velocity the rotary damper gear 18 thus regulating angular velocity of the spool 14.

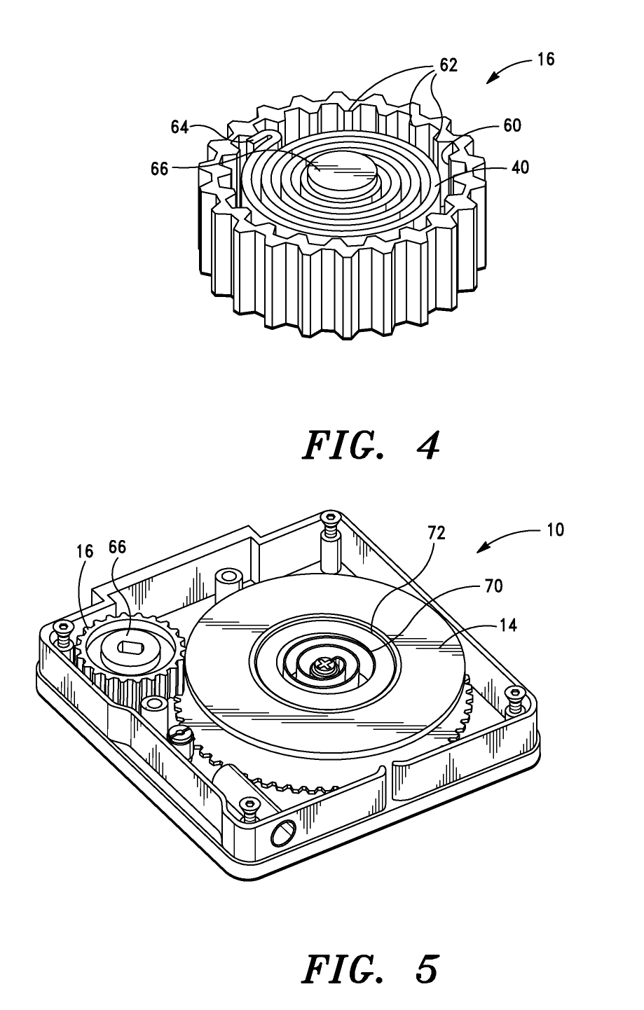

FIG. 4 shows a bottom view of a power gear 16 having a recessed interior 60. The recessed interior 60 may be partially recessed or completely hollow. The power gear 16 has both internal and external gear teeth. The power gear spring 40 mounts within the recessed interior 60.

The power gear spring 40 has a hooked end 64. The recessed interior 60 is textured. The texture, preferably, includes gear teeth 62 that mate with the hooked end 64 of the power gear spring 40. Accordingly, the tension of the power spring 40 is adjustable by selectively positioning the hooked end 64 against a desired position within the recessed interior 60.

The power gear 16 includes a centrally mounted hub 66. The power gear spring 40 attaches to the hub 66. The hub 66 may be a separate element or may be integrated into the power gear 16.

FIG. 5 shows an embodiment of the cartridge 10 having the power gear 16 mounted on a hub 66. The hub 66 is formed as part of the cartridge 10. The power gear 16 is shown in operative engagement with the spool 14. The spool 14 includes a recessed interior 72 and a spool power spring 70 mounted in the recessed interior 72. Preferably the spool power spring 70 is a spiral torsion spring. The recessed interior 72 may be partially recessed or completely hollow. Accordingly, the power gear 16 and the spool power spring 70 cooperate to rotate the spool 14. The power gear 16 provides supplemental torque to the spool.

Having a power spring 70 recessed in the spool 14 and in the power gear 16 minimizes the size of the cartridge 10. In an alternate embodiment, the power gear 16 is eliminated further minimizing the size of the cartridge 10.

While the present invention is disclosed in terms of various embodiments, including preferred embodiments, it can be appreciated that the true scope of the invention is defined only by the appended claims.

I claim:

1. A cartridge for managing an ear bud cable, comprising:
a housing having an input jack that is electronically connectable to an audio-source;
a hub fixed in the housing, the hub being electrically connected with the input jack;
a spool rotatably mounted on the hub, the spool being electrically connected with the hub;
a power gear being mounted in the housing and in contact with the spool for rotating the spool, the power gear defining a recessed interior;
an ear bud cable wrapped at least partially around the spool, the ear bud cable has a first end and a second end, the first end being electrically connected with the spool and the second end being electrically connected with at least one ear bud;
a power gear spring mounted within the recessed interior of the power gear for rotating the power gear; and
whereby rotation of the spool selectively retracts and dispenses the ear bud cable.

2. A cartridge as set forth in claim 1, wherein the power gear has external teeth, and the spool has external teeth, the teeth of the power gear mate with the teeth of the spool.

3. A cartridge as set forth in claim 2, wherein the power gear has internal teeth that engage the power spring to enable the power spring to rotate the power gear.

4. A cartridge as set forth in claim 2, wherein the power gear has internal teeth and the power gear spring has a hooked end, the hooked end of the power spring engages at least one of said internal teeth of the power gear.

5. A cartridge as set forth in claim 1, wherein the ear bud cable is flat, having a height and a width, wherein the width is more than twice the height.

6. A cartridge as set forth in claim 1, wherein the ear bud cable is flat, having a height and a width, wherein the width is more than twice the height.

7. A cartridge for managing an ear bud cable, comprising:
a housing having an input jack that is electronically connectable to an audio-source;
a hub fixed in the housing, the hub being electrically connected with the input jack;
a spool rotatably mounted on the hub, the spool being electrically connected with the hub, the spool defines a recessed interior;
a spool power spring mounted within the recessed interior of the spool for rotating the spool;
an ear bud cable wrapped at least partially around the spool, the ear bud cable has a first end and a second end, the first end being electrically connected with the spool and the second end being electrically connected with at least one ear bud; and
whereby rotation of the spool selectively retracts and dispenses the ear bud cable.

8. A cartridge as set forth in claim 7, wherein the recessed interior of the spool is hollow, the spool power spring mounts within the hollow interior of the spool

9. A cartridge as set forth in claim 7, wherein the spool power spring is a spiral torsion spring.

10. A cartridge as set forth in claim 7 further comprising a rotary damper attached within the housing and connected in operable engagement with spool to regulate rotation of the spool.

11. A cartridge as set forth in claim 7 further comprising a rotary damper attached within the housing, the rotary damper having gear teeth connected in operable engagement with the spool to regulate rotation of the spool.

12. A cartridge as set forth in claim 7 further comprising a cable guide mounted on the housing, the cable guide receives the ear bud cable to guide the ear bud cable into and out from the cartridge.

13. A cartridge as set forth in claim 7 further comprising a power gear having a recessed interior and a power gear spring mounted in the recessed interior, the power gear mates with the spool to provide supplemental torque to the spool.

14. A cartridge as set forth in claim 13, wherein the power gear spring is a spiral torsion spring.

15. A power gear for use in a cartridge for managing ear bud cables, comprising:
an exterior having gear teeth,
an interior that is recessed for holding a power spring; and
a spring mounted in the interior for rotating the power gear.

16. A power gear as set forth in claim 15, wherein the spring is a spiral torsion spring.

17. A power gear as set forth in claim 16, wherein the power gear is generally circular in shape.

18. A power gear as set forth in claim 16, wherein the power gear has a textured interior that mates with the spring.

19. A power gear as set forth in claim 16, wherein the spring has a hooked end.

20. A power gear as set forth in claim 16, wherein the power gear has two sets of peripheral gear teeth to enable the power gear to hold an ear bud cable between the two sets of peripheral gear teeth.
